(19) United States
(12) Patent Application Publication
(10) Pub. No.: US 2004/0094733 A1
(43) Pub. Date: May 20, 2004

(54) Micro-fluidic system

(76) Inventors: Robert W. Hower, Farmington Hills, MI (US); Hal C. Cantor, Farmington Hills, MI (US); Jason R. Mondro, Farmington Hills, MI (US)

Correspondence Address: Kenneth I Kohn, Kohn & Associates, Suite 410, 30500 Northwestern Highway, Farmington Hills, MI, 48334, US

(21) Appl. No.: 10/362,330

(22) PCT Filed: Aug. 31, 2001
(86) PCT No.: PCT/US01/27340

(51) Int. Cl. F16K 31/00

(52) U.S. Cl. 251/11

(57) ABSTRACT

According to the present invention, there is provided a micro-fluidic sensor system (6) including a micro-conduit (56) for carrying fluid therethrough having a flexible wall portion (18), at least one micro-fluidic actuator having a closed cavity, flexible mechanism defining a wall of the cavity (11) and flexible wall portion (18) of the micro-conduit for deflecting upon an application of pressure thereto, and expanding mechanism (14) disposed in the cavity for selectively expanding the cavity and thereby selectively flexing said expanding mechanism, and sensor mechanism in fluid communication with the micro-conduit for sensing the presence or absence of molecules. The present invention further provides for a micro-fluidic system for moving micro-fluid amounts including a micro-conduit and at least one micro-fluidic actuator in fluid communication with the micro-conduit.

### BACKGROUND OF THE INVENTION

1. Technical Field

The present invention relates to micro-fluidic systems for use in determining the presence, absence, and quantity of various chemical and biological substances in microscopic amounts of biological or other fluid samples and moving microscopic amounts of biological or other fluids.

2. Background Art

In various mechanical, electrical, chemical, biochemical, and biological arts, sampling and monitoring of fluids occur to determine various fluid components and other associated fluid characteristics. Such sampling and monitoring occur through various passive and active sampling devices and systems known to those of skill in the art. These devices often are miniaturized instruments that monitor and sample minute or micro amounts of fluids. Often, miniaturization of the instrumentation occurs in order to significantly reduce reagent amounts, increase efficient throughput, improve data collection, and decrease the need for invasive sample withdrawal.

Currently, most real-time biological monitoring systems designed for application in individuals employ implanted sensors. The major drawbacks to these systems include, but are not limited to, a need for surgical implantation, periodic calibration, occurrence of protein adsorption onto the sensor surface, and capsule formation around the sensor. Both protein contamination and capsule formation affect the performance and functionality of the sensor. Although several new biocompatible materials have been found and utilized in vivo to make ion-selective sensors, minimal protein adsorption on the surface of the sensor affects sensor accuracy and response time. Additionally, implantation trauma, such as edema, swelling, capsule formation, and antigenic rejection skew the concentrations of certain molecules at the implantation site.

In the biological arts, minimally invasive monitoring and sampling of micro amounts of fluids can occur through transdermal collection (i.e., transdermal patch). Due to the high concentration of capillaries in the dermis of a body, interstitial fluid concentrations are proportional to blood concentrations of hundreds of relevant molecules, including blood electrolytes, stress hormones, medical and recreational drugs, pesticides, and chemical warfare agents. A critical factor however, affects the utility of transdermal micro-fluidic systems. These transdermal systems must maintain a very high surface area to volume ratio.

Due to the large amount of required sample to detect molecules of interest utilizing external assay systems, it is required to perform transdermal sampling for a long duration of time. The duration of sampling can be significantly reduced by increasing the surface area to volume ratio, but large patches that cover the entire abdomen are impractical.

Another way to improve the surface area to volume ratio is to decrease the volume of the sampling system. Through the use of integrated, microscopic sensors, capable of monitoring nanoliter quantities of sample, this can be realized.

Transdermal techniques may utilize iontophoresis, osmosis, electroporation, and electro-osmosis. For instance, these transdermal techniques can be used for introducing drugs into the bloodstream and to withdraw fluids from the body. Iontophoresis utilizes either a constant current or a pulsed current to aid in the transport of charged particles across the stratum corneum (the outer layer of the epidermis, which creates a major barrier to the loss of water by the body). Direct current has been reported to cause skin irritation due to the polarization of the skin surface, while pulsed current allows this layer to have time to repolarize, maintaining natural skin permeability. When using iontophoresis for drug delivery, surfactants have been employed to increase the flow of neutral molecules across the epidermis.

Osmotic methods take advantage of concentration gradients to draw small, lipophilic ions across the skin barrier. In humans, the stratum corneum is negatively charged and, therefore, allows cationic particles to diffuse across the barrier at a much higher rate than anionic particles. Often, salt solutions are utilized to provide the osmotic gradient to draw the interstitial fluids from the body. Unfortunately, salt acts as an irritant hence reducing the amount of time that the patch may be used. However, when a sugar solution is used to provide the primary osmotic driving force, the skin does not become irritated.

Electro-osmosis is a process by which an externally applied potential is used to mobilize cations such as sodium, which freely cross the stratum corneum, to transfer their momentum to neutral molecules around them. This technique has been used to measure glucose minimally invasively, utilizing large electrodes and transdermal patches with excessively large surface areas and volumes. Researchers employing electro-osmosis on the macro-scale have successfully monitored interstitial glucose concentrations off-line, is which have been demonstrated to correlate to blood glucose concentrations, at 20-minute intervals with a temporal delay of approximately 20 minutes.

In order to sample and transport small volumes of biological or other fluids, it is necessary to have micro-fluidic devices such as micro-fluidic pumps, valves, and actuators that work to control micro-fluid flow. Typically, the actuators are the driving mechanism of these devices.

An actuator that produces out of plane movement is necessary for many chip-scale (1 mm² to 1 cm²) applications. Some of these applications include: movement of small volumes of liquid using a micro-fluidic peristaltic pump, valving of solutions to deliver different chemicals to an area on a chip, mixing of solutions in a microscopic chamber, as well as through the attachment to other devices like cilia, fans, or other devices to produce out of plane motion for a silicon micro-machined chip.

As previously stated, actuators are the driving mechanism behind pumps that force fluid through a passageway, channel, port, or the like, and can possibly function as valves in micro-fluidic devices. These actuators work by various types of actuation forces applied to a flexible mechanism, valve or other similar device. Actuation occurs through methods using various forces such as electrostatic, piezoresistive, pneumatic, electrophoretic, magnetic, acoustic, and thermal gas expansion.

Electrostatic actuation of a membrane is one of the fastest methods for pumping solutions through a system. Piezoresistive actuation is also very fast, utilizing hybrids of thick and thin films to produce a resonant structure affecting pumping of solutions. While these devices exhibit very fast actuation rates, they require very high voltages, from 100V to 200V, and 50V to 500V respectively. Additionally, electrostatic and piezoresistive actuation require specialized valves that direct fluid flow in a particular direction. As a result, these valves require three chips to be separately machined and bonded together to produce the device.

Pneumatic actuation requires an external pressurized gas source to actuate the membranes that cause fluid flow. While this method is feasible in a laboratory setting where pressurized gas is available, it is impractical for in-the-field utilization.

Electrophoretic actuation utilizes electrodes within a solution to impart a motive force to charged molecules within the solution. Neutral molecules are then ‘dragged’ along with the charged particles. This method is amenable to size reduction; however, it does have critical side effects such as the chromatographic phenomenon that causes a separation of molecules based upon charge. Additionally the high voltages necessary to induce fluid transport are incompatible with standard CMOS circuitry.

Ultrasonic actuation occurs through flexural plate waves. This methodology, however, is inefficient and causes mixing due to enhanced diffusion.

Thermal gas expansion relies on the expansion of trapped air in the system to move fluid through the conduits. This is accomplished by selectively producing hydrophobic and hydrophilic regions on the chip.

The devices from these previous bodies of work lack the ability to cost-effectively add integrated sensors or circuitry to the devices. Integrating circuitry incorporated into the micro-fluidic devices reduces: (1) the need for costly instrumentation, (2) the overall power consumption of the system, and (3) the complexity of the control signals and mechanisms. Additionally, integrated circuitry allows for the addition of chemical and physical sensor arrays, and for connection to telemetry systems for remote communication with external devices.

Most, if not all, of the micro-fluidic actuators are produced on structures that are not planar. (See, U.S. Pat. Nos. 5,962,081 and 5,726,404). Various other efforts are also underway to build miniature valves and pumps in silicon for micro-fluidics. It has been difficult to produce good sealing surfaces in silicon, and it turns out that these valves, although in principle can be mass-produced on a silicon wafer, require expensive packaging to be utilized. Consequently, such micro-fluidic components cannot be considered inexpensive and/or disposable. In addition, these micro-fluidic pumps and valves must be interconnected into systems including sensors, electronic controls, telemetric circuitry, etc. such that the interconnection becomes expensive.

Accordingly, it would therefore be useful to develop a micro-fluidic sensor system that is integrated, low power, planar, and overcomes all of the problems of the prior art.

### SUMMARY OF THE INVENTION

According to the present invention, there is provided a micro-fluidic sensor system including a micro-conduit for carrying fluid therethrough having a flexible wall portion, at least one micro-fluidic actuator having a closed cavity, flexible mechanism defining a wall of the cavity and flexible wall portion of the micro-conduit for deflecting upon an application of pressure thereto, and expanding mechanism disposed in the cavity for selectively expanding the cavity and thereby selectively flexing said expanding mechanism, and sensor mechanism in fluid communication with the micro-conduit for sensing the presence or absence of molecules. The present invention further provides for a micro-fluidic system for moving microscopic amounts of fluid including a micro-conduit and at least one micro-fluidic actuator in fluid communication with the micro-conduit.

### DESCRIPTION OF THE DRAWINGS

Other advantages of the present invention are readily appreciated as the same becomes better understood by reference to the following detailed description when considered in connection with the accompanying drawings wherein:

FIG. 1 is a schematic CAD layout of an embodiment of a micro-fluidic chip of the present invention including pumps, mono-stable valves, sensor chambers, and buffer/calibration/wash reservoirs (size 8 mm×4 mm);

FIG. 2 is a CAD layout of an embodiment of a micro-fluidic chip utilizing a bi-stable valve design (size=8 mm×4 mm);

FIG. 3 is a schematic layout of an embodiment of a micro actuator;

FIG. 4 is a CAD layout of another embodiment of a micro actuator;

FIG. 5 is a schematic layout of an embodiment of a micro-fluidic pump;

FIG. 6 is a picture of an embodiment of a flexible mechanism of the present invention in an expanded position;

FIG. 7 is a schematic diagram of an embodiment of the present invention of a sensor array of the present invention with rectangular electrode geometry;

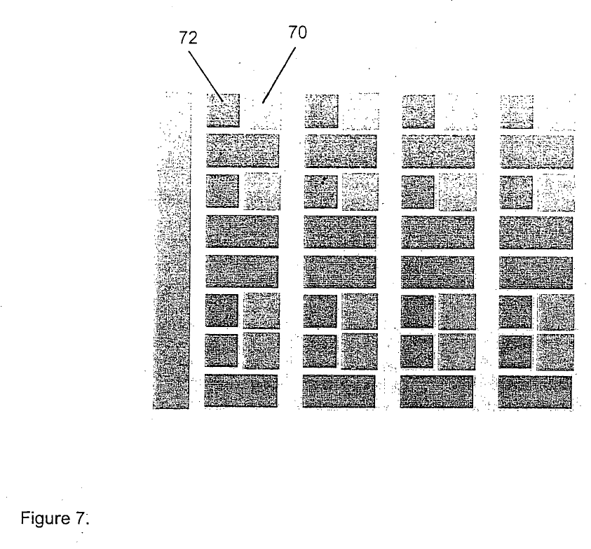

FIGS. 8A and B are schematic views of an embodiment of a bi-stable valve, wherein 8A is a top view of an embodiment of the bi-stable valve and 8B is a cross-sectional view of an embodiment of the bi-stable valve;

FIGS. 9A and B illustrate an embodiment of a mono-stable valve in a normally open and actuated closed state, respectively;

FIG. 10 is a side, elevational cross section view of an embodiment of the micro-fluidic system, wherein arrows indicate fluid flow;

FIG. 11 a side, elevational cross section view of another embodiment of the micro-fluidic system; and

FIG. 12 is a top view of a layout of an embodiment of a sampling chamber of the present invention with teardrop-shaped standoff posts.

### DETAILED DESCRIPTION OF THE INVENTION

Generally, the present invention provides an automated micro-fluidic sensor system, generally shown at 6, which is capable of numerous applications and uses. The present invention can be passive and be connected to external circuitry or can be active and use integrated circuitry. Additionally, the present invention can be connected to various accessory devices such as telemetric transmitters, GPS systems to monitor location, audible alarm devices triggered by presence or absence of materials in fluids, solid-state sensors for analysis of fuel cell effluent or biological samples, and any other similar accessory devices known to those of skill in the art.

The present invention can be a micro-fluidic system that monitors minute samples such as tears, saliva, urine, interstitial fluids, and the like. The present invention can also be used in devices that detect toxic materials such as engine fuels, methanol, chemical warfare weapons, and neurotoxins, biological markers such as blood electrolytes, blood glucose, therapeutic drugs, drugs of abuse, pesticides, herbicides, and hormones, and any other similar compound or substance known to those of skill in the art. Additionally, the present invention can be utilized in micro hydraulic systems, lubrication device systems, fuel cell systems, microvilli systems, micro-fan systems, and other similar systems known to those of skill in the art.

The present invention is aimed to work under a variety environmental of conditions. For instance, they can function at an extremely wide temperature range, but typically work in ranges of 10° C. to 90° C. Additionally, the present invention functions in various atmospheric pressures such as 0.1 ATM to 3.00 ATM.

The term “actuator” as used herein is meant to include, but is not limited to, a device that causes something to occur. The actuator 10 activates the operation of a valve, pump, villi, fan, blade, or other microscopic device. Typically, the actuator 10 of the present invention affects fluid flow rates within a chamber.

The term “closed cavity” 11 as used herein is meant to include, but is not limited to, a sealed cavity that contains a liquid or solid expanding mechanism 14 that is expanded or vaporized to generate expansion or actuation of a flexible mechanism 18. The closed cavity 11 must be completely sealed in order to contain the expansion therein, and must be flexible on at least one side.

The term “expanding mechanism” 14 as used herein is meant to include, but is not limited to, a fluid 14 capable of being vaporized and condensed within the closed cavity 11 enclosed by the flexible mechanism 18. The expanding mechanism 14 operates upon being actuated or heated. The expanding mechanism 14 includes, but is not limited to, water, wax, hydrogel (solid or non-solid), hydrocarbon, and any other similar substance known to those of skill in the art. Condensation of the expanding mechanism 14 occurs when the heat, which is generated to induce expansion of the is expanding mechanism, is removed by a surrounding medium such as a gas, liquid or solid. Then, once condensation occurs, contraction of the flexible mechanism takes place.

The term “flexible mechanism” 18 as used herein is meant to include, but is not limited to, any flexible mechanism 18 that is capable of expanding and contracting with the vaporization and condensation of the expanding mechanism 14. The flexible mechanism 18 must be able to stretch without breaking when the expanding mechanism 14 is vaporized. The flexible mechanism 18 is made of any material including, but not limited to, silicone rubber, rubber, polyurethane, PVC, polymers, combinations thereof, and any other similar flexible mechanism known to those skilled in the art.

The term “heating mechanism” 12 as used herein is meant to include, but is not limited to, a heating device 12 that is incorporated with the actuator 10 of the present invention. The heating mechanism 12 generates heat to induce expansion of the expanding mechanism 14. The heating mechanism 12 is disposed adjacently to the flexible mechanism 18 in order to turn on and off and maintaining on and off selective expansion of the expanding mechanism 14. The heating mechanism 12 can be powered using any power source known to those of skill in the art. In an embodiment, the heating mechanism 12 is powered by a battery. However, both AC and DC mechanisms are used to minimize power requirements. Generally, the heating mechanism 12 is formed of materials including, but not limited to, polysilicon, elemental metal, silicide, or any other similar heating elements known to those of skill of the art. Moreover, the heating mechanism 12 is disposed within a medium such as SiO₂ or other solid medium known to those of skill in the art.

The term “temperature sensor” as used herein, is meant to include, but is not limited to, a device designed to determine temperature. A resistive temperature sensor 16 is made from material including, but is not limited to, polysilicon, elemental metal, silicide, and any other similar material known to those of skill in the art. Thermocouple temperature sensors can also be used. Typically, the temperature sensor 16 is situated within or near the heating element of the heating mechanism 12.

The terms “chamber,” “micro chamber,” “pulsating micro chamber,” “micro-conduit,” and “conduit” as used herein are meant to include, but not limited to, any type of tube, pipe, planar channel, conduit, or any other similar chamber known to those of skill in the art. The conduit has a wall mechanism made from material including, but not limited to, silicon, glass, rubber, silicone, plastics, polymers, metal, and any other similar material known to those of skill in the art. In one embodiment of the micro-fluidic valve, the chamber encompassing the micro-actuator is etched out of glass in a nearly hemispherical shape. A variety of conformations of spherically cut patterns (i.e. ⅓ of a sphere, ½ of a sphere, etc.) with differing radii and footprints are employed to provide different valving characteristics.

The micro-fluidic system can be incorporated into a “dermal patch” that contains the sensor system, interstitial fluid sampling system, calibration system, pumping system, and electronics for device control, sensor monitoring, and incorporation into a telemetry system to name a few functions. The resulting micro-fluidic sensor system has the capability to continuously monitor the concentrations of a large number of relevant biological molecules continuously from an ambulatory patient and has the ability to trigger an audible alarm in the case of dangerous exposure to hazardous materials or out-of-therapeutic range for medicinal drugs, or provide closed-loop injection of therapeutic drugs.

With regard to patches, a key feature is that the present invention is well suited in being able to obtain micro-amounts of fluids from a smaller surface area. Smaller area electrodes (less than 1 cm²) with an equivalent current density do not produce as significant physiological “side-effects,” compared to large electrodes; however, the reduced surface area results in a significantly reduced volume of drawn interstitial fluid. By reducing the test volume required for analysis by three orders of magnitude, the surface area of the transdermal patch can be significantly reduced by utilizing microscopic semiconductor sensors.

In one embodiment, the present invention includes test chambers designed for a microscopic volume (50 nL), therefore, minimal calibration solution is required. Additionally, very stable amperometric and potentiometric sensors that require calibration only 2-4 times/day to maintain accuracy are utilized. The transdermal buffer sampling solution consists of a combination of enough salt to provide electrical connectivity and a high concentration of sugar to provide the osmotic gradient to induce osmotic flow of interstitial fluids. In addition to buffer solutions, calibration solutions and washing solutions are employed within the system.

The actuators 10 of the present invention are the driving mechanism behind various devices of the present invention. The micro-fluidic valves have various pressures and temperatures required for their actuation. The peristaltic pump is selectively controlled and actuated through an integrated CMOS circuit or computer control, which controls actuation timing, electrical current, and heat generation/dissipation requirements for actuation. Integration of control circuitry is important for the reduced power requirements of the present invention. In one particular embodiment for example, sensors and circuitry responsible for monitoring the effluent of a fuel cell with concomitant control of the micro-fluidic fuel delivery system to increase or decrease the flow rate of fuel is designed. This ensures optimal fuel utilization in the device. Closed loop feedback provides the basis of automated adjustment of circuitry within the micro actuator.

The actuator 10 includes a closed cavity 11, flexible mechanism 18, and expanding mechanism 14. Fabrication of actuators 10 is accomplished by generating electron-beam and/or optical masks from CAD designs of the micro-fluidic system. Then, using solid-state mass production techniques, silicon wafers are fabricated and the flexible mechanisms 18 for the actuators are subsequently placed on the chips.

In the device without integrated circuitry, the control circuitry is produced on external breadboards and/or printed circuit boards. In this manner, the circuitry is easily, quickly, and inexpensively optimized prior to miniaturization and incorporation as CMOS circuitry on-chip that can be controlled manually, or through the use of a computer with digital and analog output. Optimized CMOS circuitry, modeled utilizing CAD solid state MEMS and CMOS design and simulation tools, is integrated into the active device making it a stand-alone functional unit.

Using an arbitrary wave-form generator, and/or computer controlled digital-to-analog (d/a) and analog-to-digital (a/d) PCI computer cards (for example, the PCIMIO16XH, National Instruments) the optimal operating parameters (i.e., stimulatory waveform patterns) are configured to generate peristaltic pumping action. Electronic control of the actuators 10 is optimized to maximize flow rates, maximize pressure head, and minimize power utilization and heat generation. Another parameter that is evaluated includes the temperature profile of the medium being pumped. To minimize power consumption and heat generation, a resistor-capacitor circuit is utilized to exponentially decrease the voltage of the sustained pulse. Further, integrated circuitry initiation and clocking of the circuitry provide control of the second-generation actuators.

An e-prom is also included on-chip to provide digital compensation of resistors and capacitors to compensate for process variations and, therefore, improve the process yield. Electrical access/test pads are designed into the chips to allow for the testing of internal nodes of the circuits.

The flexible mechanism 18 deflects upon the application of pressure thereto. In one embodiment, the flexible mechanism 18 is screen-printed over the expanding mechanism 14 utilizing an automated screen-printing device, a New Long LS-15TV screen printing system. The flexible mechanism 18 is very elastic and expands many times its initial volume as the expanding mechanism 14 under the flexible mechanism is vaporized. Due to the large deflection, it is possible to completely occlude: a micro-channel with this flexible mechanism 18, hence providing the functionality of an electrically actuated microscopic valve. The present invention can also apply flexible mechanism 18 with syringe or pipette devices or spin coat it on the entire wafer. Photo curable membrane can also be used to pattern the flexible mechanism 18 on the wafer.

A wide variety of commercially available polymers can be utilized as the flexible mechanism 18, including, but not limited to: Polyurethane, PVC, and silicone rubber. The actuator flexible mechanism 18 must possess elastomeric properties, and must adhere well to the silicon or other substrate surface. A material with excellent adhesion to the surface, as well as appropriate physical properties, is silicone rubber.

In an embodiment of the present invention, the flexible mechanism 18 is made of silicone rubber. The silicone rubber can be dispensed utilizing automated dispensing equipment, or can be screen-printed directly upon the silicon wafer. Screen-printing methods have the advantage that the entire wafer, containing hundreds of pump and valve actuators 10, can be produced at once. By varying the amount of solvent in the polymer, such as silicone rubber, the flexible mechanism 18 thickness and its resulting physical force characteristics can be precisely controlled.

The flexible mechanism 18 can serve the dual purpose of actuation as well as serving as the bonding material used to attach the liquid flow channels to the silicon chip containing the actuators 10. By covering the entire area of the chip with the flexible mechanism 18, with the exception of the sensing regions and the bonding pads, the glass or plastic channels can be “glued” to the actuator 10 containing silicon chip. This method provides additional anchoring and strength to the actuation flexible mechanism 18, and allows the actuation area to encompass the entire actuation chamber 20. The only drawback to this method is potential protein and/or steroid adsorption onto the micro'fluidic conduits 56. However, with proper flexible mechanism 18 selection and chemical treatment, molecular adsorption can be minimized, or a second, thin, inert layer can be used to coat the flexible mechanism 18.

The expanding mechanism 14 selectively expands the cavity 11 defined by the flexible mechanism 18 thereof and thereby selectively flexes the flexible mechanism 14. The expanding mechanism can be made of various materials. In one embodiment, the expanding mechanism is a hydrogel material, which contains a large amount of water or other hydrocarbon medium, which is vaporized by the underlying heating mechanism. In this embodiment, the volume of hydrogel needed to produce the desired actuation and pressure for the flexible mechanism 18 is approximately 33 pL. With this design, approximately 97% of the energy generated by the heating mechanism 12 is transferred into the hydrogel for vaporization.

A practical technique for the micro-fluidic pumping of moderate volumes of liquid is through the use of peristaltic pumping utilizing pneumatic actuation. The integrated micro-fluidic pumping system of the present invention is designed to sample small amounts of interstitial fluid from the body on a continuous basis. In order to analyze the microscopic volumes, silicon micro-machining methods and recent improvements in membrane deposition technologies are utilized to produce a microscopic test chamber 60 on the order of 50 nL in volume, roughly 3-4 orders of magnitude less volume than current systems. In addition to the improved response time, the reduction to microscopic volumes allows the use of very small amounts of calibration solution to effect calibration and rinsing, hence reducing the overall size of the package. In some systems the calibration solutions are a significant portion of the entire package (Malinkrodt Medical/IL) where, even though miniature sensors are used, liters of calibration solutions are necessary.

In one embodiment, the micro-fluidic pump design is based upon electrically activated pneumatic actuation of a micro-screen printed silicon rubber membrane. Generally, the pump includes the micro-fluidic actuator 10 including a closed cavity 11, flexible mechanism 18 defining a wall of the closed cavity 11, and expanding mechanism 14 disposed within the closed is cavity. The flexible mechanism 18 deflects upon the application of pressure thereto and the expanding mechanism 14 selectively expands the cavity and thus flexible mechanism 18 and thereby selectively flexes the expanding mechanism 14.

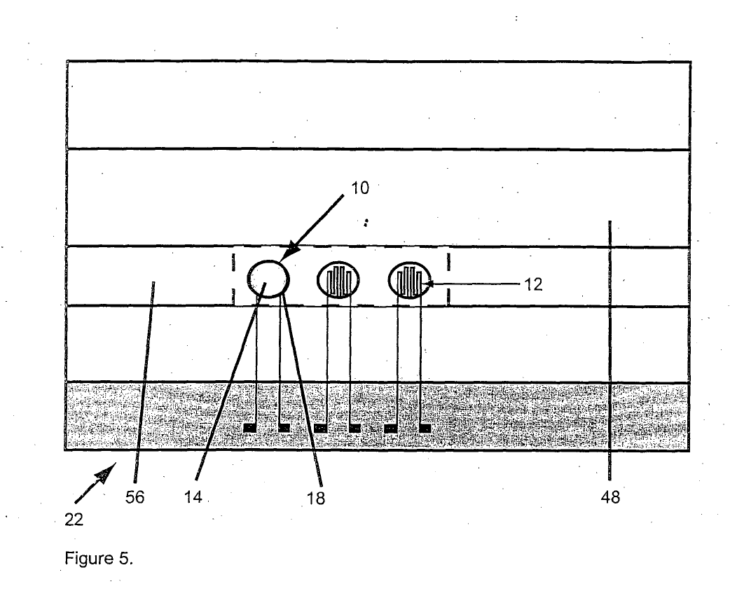

The micro-fluidic actuator 10 is based upon electrically activated pneumatic actuation of a micro-screen-printed or casted flexible mechanism 18. The peristaltic pump, generally includes three actuators 10 placed in series wherein each actuator 10 creates a pulse once it is activated (See FIG. 5). By working in tandem, the actuators 10 peristaltically pump fluids. The optimal firing order and timing for each actuator 10 depends upon the requirements for the system and are under digital control to create the peristaltic pumping action.

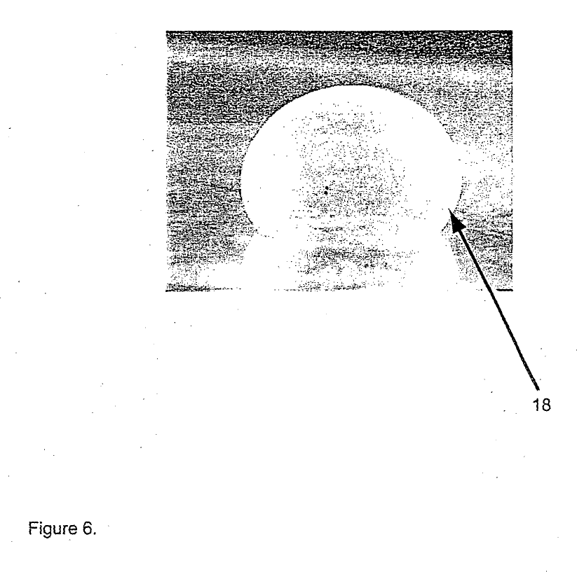

The advantage of pneumatic actuation is that large deflections can be achieved for the flexible mechanism 18 (See FIG. 6). To actuate the flexible mechanism 18, a vaporizable fluid 14 is heated and converted into vapor to provide the driving force. Utilizing an integrated heating mechanism 12, the expanding mechanism 14 is vaporized under the flexible mechanism 18 to provide the pneumatic actuation. This actuation occurs without the requirement of utilizing external pressurized gas.

The liquid or gaseous fluid being pumped serves the purpose of acting as a heat sink to condense the vapor back to liquid and hence return the flexible mechanism 18 to is relaxed state when the heating mechanism 12 is inactivated. A temperature sensor 16 is integrated adjacent to the actuator 10 to monitor the temperature of the micro-fluidic integrated heating mechanism 12 and hence, expanding mechanism 14.

The heating mechanism 12 requires very low power to achieve sufficient temperatures for fluid vaporization. As an example, miniature ink-jet nozzles that require temperatures in excess of 330° C., utilize 20μ second pulses of 16 mA to heat the fluid and fire an ink droplet. Considerably lower power would be required to vaporize the liquid in the present micro-fluidic pump application. In the field, it is necessary to utilize low power devices and circuitry to conserve energy and allow the use of very small, lightweight, film or button batteries.

Once the heating mechanism 12 is activated, vaporization of the expanding mechanism 14 takes place. The expanding mechanism 14 component imposes a pressure upon the flexible mechanism 18 causing it to expand and be displaced above the heating mechanism 12 and reduce the volume of the chamber 20. This methodology can be utilized to displace fluid between the flexible mechanism 18 and the walls of the chamber 20 (pumping action), to occlude fluid flow through the chamber 20 (valving action), to provide direct contact to the glass substrate to effect heat transfer, or to provide the driving force for locomotion of a physical device (i.e., as in a walking caterpillar and/or a swimming paramecium with a flapping flagella, in which case the glass chamber 20 encompassing the micro-actuator 10 would not be used).

The heat flux through each of the layers composing the device is calculated using existing boundary conditions. The temperature required to vaporize the expanding mechanism 14 varies according to the physical and chemical properties of the expanding mechanism 14 itself. Due to the differences in heat transfer through liquid versus gas, approximately twice as much heat flux travels through the device when the expanding mechanism 14 is all liquid compared to all vapor. In order to reduce heat dissipation into the medium being pumped, while the expanding mechanism 14 is in the liquid state, the heating mechanism 12 is quickly ramped to the temperature required to vaporize the liquid. Once the expanding mechanism 14 is vaporized, heat transfer to the medium being pumped is minimized.

In one embodiment, the temperature of the saturated liquid hydrogel, at 1 ATM, is assumed to be 100° C. The heat flux to the air, through the back of the heating mechanism 12, is calculated to be 1263 W/K-m². The total heat flux through the device is calculated to be 46,995 W/K-m² with a total-flux from the heating mechanism 12 of 47,218 W/K-m² (i.e. 97% efficiency of focused heat transfer). In this embodiment, the temperature of the inactive state hydrogel varies between 86° C. and 94° C.

The temperature of the activated, vapor state hydrogel is approximately 120° C., which is the saturation temperature for steam at 2 ATM. The heat transfer coefficient for convection can be calculated directly from the thermal conductivity. The heat flux to the air through the back of the heating mechanism 12 is 2818 W/K-m². The heat flux through the device is 21,352 W/K-m² with a total flux from the heating mechanism 12 of 24,170 W/K-m². When the aqueous component of the hydrogel is completely in the vapor state, there is no fluid 14 in the channel and the thin film of solution between the flexible mechanism 18 and the glass is approximately at 60° C. These values and calculations vary according to the type of actuator, valve, pump, and micro device being used.

In an embodiment of the present invention, the volume of the expanding mechanism 14, in this case, liquid hydrogel, is determined based on the volume of vapor needed to expand the flexible mechanism 18 completely at 2 ATM using the ideal gas law. This assumption is valid because the temperatures and pressures are moderate. The volume of liquid hydrogel necessary to achieve this volume of gas at this pressure, assuming the hydrogel is 10% water and all of the water is completely evaporated, is 0.033 nL. Cylindrically shaped sections of hydrogel are utilized within the actuator 10. This shape has been chosen to optimize encapsulation by the actuator flexible mechanism 18. The cylinders have either a diameter of approximately 140 μm and a height of 2.14 μm, or a diameter of 280 μm with a height of 0.54 μm (identical volumes, different orientation to the heating element). Of course, the shapes and volumes vary according to the type of expanding mechanism being used. For example, photocurable liquid hydrogels have different parameters.

For flexible mechanism 18 actuation and hydrogel vaporization, it is necessary to raise the temperature of the hydrogel from ambient temperature to the boiling point, 120° C. at 2 ATM. Thermodynamic models indicate that approximately 8.03×10⁻⁷ J of heat transfer is required to raise the temperature of the hydrogel from 37° C. to 120° C. (1.08×10⁻⁷ J) and vaporize all of the water (6.95×10⁻⁷ J). This is consistent with the sum of enthalpy equation.

In another embodiment, for flexible mechanism 18 contraction and expanding mechanism 14 condensation, it is assumed that all heat dissipation from the activated, vaporized expanding mechanism 14, as it condenses, is transferred into the solution being pumped. The calculation for this condensation involves condensing all of the water in the hydrogel plus sub cooling the hydrogel from 100° C. to 90° C. in order to completely contract the actuator 10. Modeling conduction through the actuator 10 flexible mechanism 18 using Fourier's equation provides a flux of 0.0015 J/s and a condensation time of 0.00473 seconds. This represents a worst case scenario, neglecting thermal conduction to the silicon substrate.

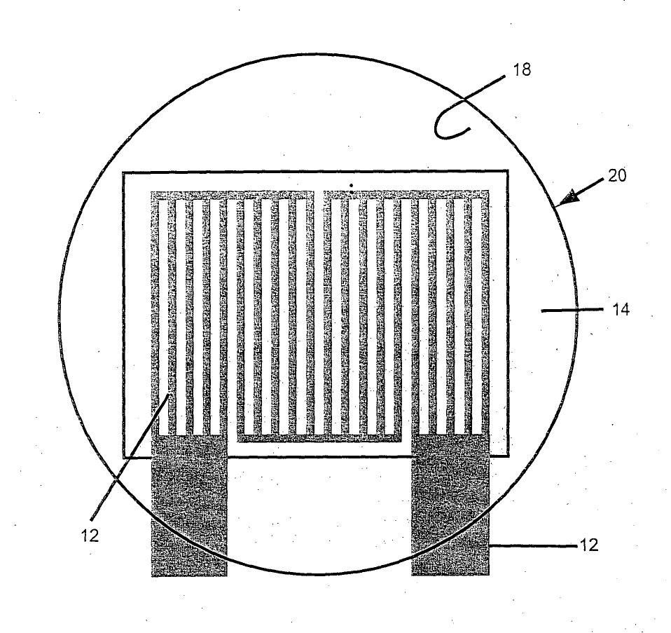

In an embodiment of the present invention, based upon the geometry of the 100 μm tall chamber 20, it is calculated that a circular actuator 10 with a diameter of 300 μm is required to deliver 4.9 nL quantities of liquid per actuation of the flexible mechanism 18. The heating mechanism 12 is laid out as a square that encompasses the majority of the circular expanding mechanism 14 area without extending past the edge of the chamber 20. Other shapes are also employed, such as circular and triangular layouts to encompass as much of the expanding mechanism 14 as possible. In order to provide: efficient micro-actuation in 150 μs, requirements for the heating mechanism 12 power output and electrical resistance are calculated. To provide the required 777 nJ of energy, the resistance of the poly-silicon heating mechanism 12 is calculated to between 450 to 500 Ω, based upon utilizing a 5V power supply. Actuation requires a 150 μs pulse of approximately 11 mA of current, providing the 777 nJ of energy required. In order to achieve a pumping rate of 10 μL/minute, approximately 677 μW of power is required. In previous work, poly-silicon structures at a thickness of 6000 Å, having a resistance of 15 Ω/elemental square have been produced. To provide the required resistance, 5 poly-silicon heating mechanism 12 lines are arranged in parallel (See FIG. 4). The poly-silicon heating mechanism 12 elements have a width of 5 μm. The total resistance of the heating mechanism 12 is 450 Ω.

In this case, the heating mechanism 12 is poly-silicon, but can be any similar material or mechanism, such as direct metals, known to those of skill in the art. Because of its high thermal conductivity, the silicon substrate acts as a heat sink. To reduce thermal conduction to the silicon substrate, a window in the silicon, located beneath the heating mechanism 12, provides the expanding mechanism 14 with an isolated platform. This window is only slightly larger than the heating mechanism 12 to maintain some thermal conduction to the substrate. After the actuator 10 is energized, thermal conduction to the silicon provides decreased time to condense the liquid in the expanding mechanism 14. This decreases constriction time and provides improved pumping rates. If the window is significantly larger than the actuator 10, there is no heat conduction path to the substrate, hence increasing condensation time and decreasing the maximal flow rate.

In one embodiment, the expanding mechanism 14 hydrogel is presented as a cylinder with diameter of 280 μm and height of 0.5-1 μm. The actuation chamber 20 encompasses the entire cavity etched in the glass substrate.

Fabrication of this device is based upon the development of a process flow. The fabrication process utilizes bulk silicon micro-machining techniques to produce the isolation windows, and thick film screen printing techniques, spin coating, mass dispensing, or mechanical dispensing of actuation membranes.

A polymeric hydrogel (or hydrocarbon) can be utilized to provide a physically supportive structure that withstands the application of flexible mechanism 18 as well as to provide the aqueous component required for actuation. Several commercially available materials meet these requirements. A hydrogel is selected that contains approximately 30% aqueous component that vaporizes near 100° C. Several materials have been identified, each of which is suitable in this application, including, but not limited to, hydroxyethylmethacrylate (HEMA) and polyvinylpyrrolidone (PVP). Additionally, hydrocarbons can be used since they possess lower boiling points than aqueous hydrogels, and therefore require less power to effect pneumatic actuation.

Dispensing hydrogel (or hydrocarbon) into the desired location is accomplished utilizing one of three methods. First, a promising method for patterning the hydrogel is to utilize a photopatternable-crosslinking hydrogel. The hydrogel is cross-linked by incorporating an UV photo-initiator polymerizing agent within the hydrogel that cross-links when exposed to UV radiation. Using this technique, the hydrogel would be evenly spun on the entire wafer using standard semiconductor processing techniques. A photographic mask is then placed over the wafer, followed by exposure to UV light. After the cross-linking reaction is completed, excess (non-cross-linked hydrogel) is washed from the surface.

The second method involves dispensing liquid hydrogel into well-rings created around the poly-silicon heating mechanism 12. These wells have the ability to retain a liquid in a highly controlled manner. Two photopatternable polymers have been utilized to create microscopic well-ring structures, SU-8 and a photopatternable polyimide. These well-rings can be produced in any height from 2 μm to 50 μm, sufficient to contain the liquid hydrogel. Once the hydrogel solidifies, flexible mechanisms can be deposited over them. This can be accomplished in an automated manner utilizing commercially available dispensing equipment.

In a third alternate method, a pre-solidified hydrogel is used that has been cut into the desire size and shape. This is facilitated by extruding the hydrogel in the desired radius and slicing it with a microtome to the desired height, or by spinning the hydrogel to the desired thickness and cutting it into cylinders of the desired radius. Utilizing micro-manipulators, the patterned gel is placed in the desired area. This process can also be automated.

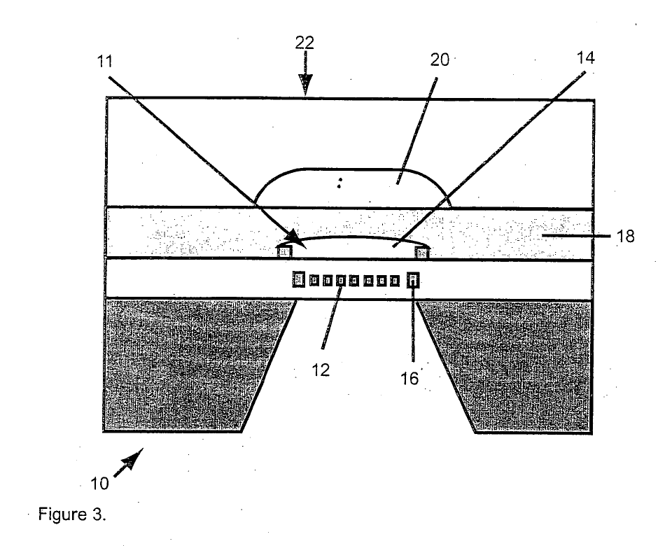

It is assumed that the temperature on both sides of the SiO₂ that encapsulates the heating mechanism is constant, and that heat flux in each direction is dependant upon the heating mechanism 12 temperature and the resistance to heat flow either through the device or to an air pocket on the heating mechanism backside. A schematic of a cross section of the actuator device is provided in FIG. 3. Steady-state heat flow through the entire actuator, for the fully actuated state, the intermediate state, and the resting state are modeled. These data are calculated for the static case during which time no fluid flow is occurring (i.e. steady-state; the system is poised at 100° C., waiting to be initiated). The fluid temperature is greater for the contracted state since the liquid hydrogel conducts heat at a greater rate than vapor. Once fluid flow is initiated, the temperature of the solution is raised by only a few degrees Celsius.

A typical problem experienced with many micro-fluidic designs revolves around the methodology for mixing of solutions and reagents. The micro-fluidic peristaltic pump design of the present invention provides mixing action in concert with the pumping action. To construct the micro-fluidic valves and pumps in a manner compatible with the sensor technologies and to integrate the entire system on a single silicon chip, the pump is preferably fabricated using planar MEMS technologies that do not require special wafer bonding, although other methods of fabrication can also be used as are known to those of skill in the art.

For encapsulating a liquid within a silicone rubber membrane, micro-machining techniques, including wafer bonding of multiple chips, are used by others to create a cavity where the liquid is stored. This requires several machining steps to produce the actuator, reducing the overall yield of functional pumps and valves, and increasing the cost.

By properly placing the planar actuators within the fluidic channels, micro-pumps, fluidic multiplexers, and valves can be formed. CAD/CAM tools are used to design the photo-masks. This can be accomplished in conjunction with the design of the fluidic channels, ports, and test chambers.

The pneumatically actuated membrane is utilized to produce the micro-fluidic valves. The micro-fluidic actuator's silicone rubber membrane is very elastic and expands many times its initial volume as the liquid under the membrane is vaporized (See FIG. 6). At least two techniques for the valving of solutions can be used.

The first utilizes the flexible mechanism 18 actuation to completely fill a micro-fluidic channel when actuated, hence providing the functionality of an electrically actuated microscopic valve. The second utilizes the flexible mechanism 18 to occlude an orifice to block fluid flow.

The pneumatically actuated membrane is also utilized to produce the micro-fluidic pumps. The micro-fluidic actuator's flexible membrane is very elastic and expands many times its initial volume as the liquid under the membrane is vaporized (See FIG. 6). The micro-fluidic channels are designed such that all media flow is in the laminar regime while minimizing fluid volume, dead volume, and residence time. Further, the routing of the micro-fluidic channels is designed such that the required calibration and wash solutions can be routed into the sensing chamber. The channels and sensing chamber accommodate approximately 50 nL volumes of solution.

Once modeled and optimized, photomasks are created for the fluidic system. Valves at the various ports are optimally designed to start and stop the flow of the various calibration and wash solutions.

In one embodiment, the integration of a sampling system to the device allows transdermal sampling techniques for the acquisition of interstitial fluids. This sampling chamber 60 has a maximized surface area within the confines of the device and an extremely minute volume to reduce the required sample volume and to decrease the sampling time. This chamber is micro-machined into the backside of the glass fluidic channel chip.

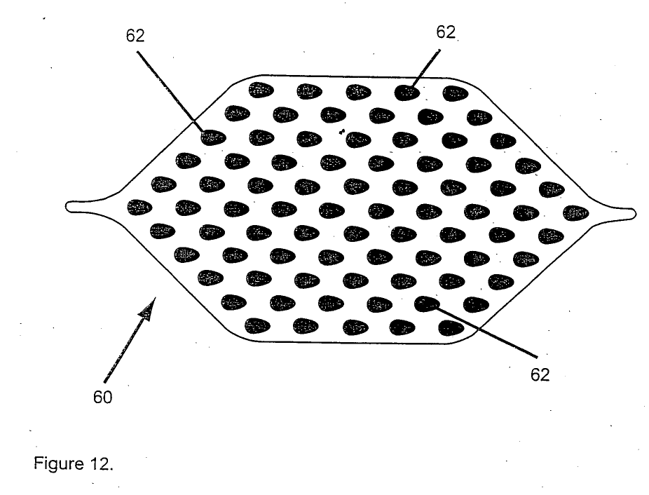

Due to the high surface area to volume ratio required in order to effect transdermal sampling, the sampling chamber 60 is designed to be very thin, approximately 20 μm in height (FIG. 12). The sampling chamber 60 include stand-off posts 62, which serve two functions. First, they are required to keep the skin from conforming to the chamber surface 64 thereby occluding the volume of the chamber. Second, they effect fluid flow within the sampling chamber 60 and promote sampling mixing. The simplest design is to produce the posts as cylinders perpendicular to the skin 66. Teardrop shaped posts 62 reduce dead volume and create eddies along the back side of the posts. Teardrop shaped posts 62 are approximated by two connected cylinders, one with a smaller diameter adjacent to one with a larger diameter and filling the space between the two. Since the posts are etched out of the glass, most any continuous shape can be produced.

The posts 62 are staggered in a triangular pitch to support the skin 66 evenly. To improve mixing of the solution and reduce molecular diffusion time, eddies can be forced in the chamber 60. If more eddies are desired, the posts can be designed with a flat and wide profile in the direction of flow. The posts 62 are shown in the CAD layout of the sampling chamber 60 (FIG. 12). The chamber 60 utilizes a gradual expansion to eliminate dead zones and eddy currents, as described for the sensor chamber 60. In one embodiment, the sampling chamber 60 approximately is 5 mm long (left to right) and 2.4 mm wide at the widest region. The chamber is etched to 20 μm deep to provide the very high surface area to volume ratio required for transdermal sample acquisition. The total area of the chamber 60 is 9.1 mm², and the area of the posts 62 is 2.07 mm². The posts 62 constitute 22% of the total cross sectional area of the sampling chamber 60. Therefore, the total exposed skin area is 7 mm² and the volume of the chamber 60 is 140 nl.

The most important factor for sampling interstitial fluids transdermally is the surface to volume ratio. As the surface to volume ration increases, the efficiency of transdermal fluid sampling increases. In the prior art, the most efficient transdermal sampling devices utilize a surface to volume ratio of 2×10³ mm²/mL. The present invention possesses a ratio of at least of 5×10⁴ mm²/mL: effectively at least 25 times the surface area to volume ratio of the best device reported in the literature.

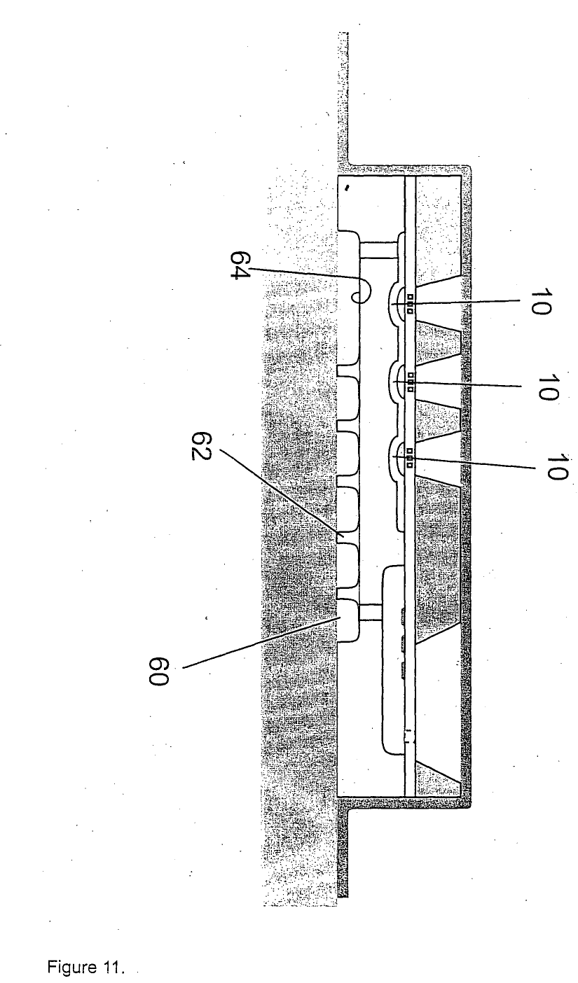

FIG. 11 depicts a schematic cross-section of a portion of the chip that contains the transdermal sampling chamber 60. The micro-fluidic pumps are utilized as the driving force for the transdermal monitoring system 6. The transdermal monitoring system includes an insulating air gap that improves the thermodynamic and electrical efficiency of the micro-actuators, integrated heater mechanisms 12, three micro-actuators 20 in series to effect peristaltic pumping, integrated amperometric/potentiometric/optical sensor arrays 70, 72, and the waste fluid reservoir 74.

The reservoirs are 1 mm squares that have miniature, silicone membrane based “pouches” attached. These can contain buffer, calibration, and wash solutions for calibration of sensors, regeneration of sensor reactions, and buffering of the interstitial fluid samples. The volumes of fluids can be altered by attaching different sized “pouches”.

There was developed a device for ambulatory measurement, collection, wireless transmission, and electrodes responsible for transdermal sampling, and/or chemical and physical sensing. The reference electrode included in each sensor site and the global reference electrode were coated with silver (Ag) and electrolytically chloridized to provide reversible Ag/AgCl electrodes.

The fabrication process entails the use of a reactive ion etch (RIE) plasma as a chloride source. This technique allows wafer level chloridation of all reference electrodes within each sensor array at once, prior to separating the silicon wafer into individual chips. This methodology eliminates the necessity to provide electrolysis current during chloridation and improves the accuracy and precision of the silver chloride fabrication process.

Through the use of integrated ion selective electrodes (ISEs), a wide variety of important ions are detectable including electrolytes, stress hormones, CO₂, local anesthetics, a variety of herbicides, heparin, medicinal drugs, lithium, etc. Additionally, amperometric sensors are utilized to detect a large variety of more complex molecules, including proteins. More complex and/or non-oxidizable molecules, such as neurotoxins and other molecules of biological warfare, are detected by immobilizing antibodies and/or enzymes on the surface of an ion-selective membrane and performing enzyme assays or enzyme-linked immunosorbent assay (ELISA) for example.

The micro-fluidic system 6 described herein, including integrated sensors, enables the system to deliver known quantities of samples, wash solutions, enzymes, reagents, and chromophores to the sensor chambers, allowing the processing and analysis of minute quantities of the sample fluid. The small size and mass producibility of the assay system, including pumps and valves, allows for low cost, disposable devices (laboratories-on-chip) to be produced. The micro-fluidic system 6 described herein significantly reduces the sample processing time periods as well as provides the ability to monitor dozens of other biological molecules on-line and in near real-time.

Iontophoretic and electro-osmotic methods are becoming more acceptable for the delivery of therapeutic levels of drugs. These techniques utilize electrodes to deliver electrical current to the skin surface to enhance the delivery system. Operated in reverse, each of these techniques can be used to remove small amounts of interstitial fluid from the body for measurement. In the present invention, iontophoresis is used to both acquire interstitial fluid samples as well as to deliver therapeutic levels of drugs under closed-loop control based upon integrated sensor analysis of the interstitial fluid samples, however other transdermal sampling techniques, known to those skilled in the art, can be utilized, such as osmosis, iontophoresis, electro-osmosis, and electroporation.

Capable of employing each of these methods, the integrated micro-fluidic system 6 is designed to withdraw small amounts of interstitial fluid from the body on a continuous basis. A minor temporal delay is incurred due to the homeostatic relationship between blood and interstitial fluid as well as mass transport. The temporal delay can be effectively reduced by reducing the volume of the testing chamber several orders of magnitude and by developing analysis algorithms.

Additionally, very stable amperometric 72 and potentiometric 70 sensors have been developed that require calibration only 2-4 times/day to maintain accuracy. The transdermal sampling buffer solution consists of a combination of enough salt to provide electrical connectivity and a high concentration of sugar to provide the osmotic gradient to induce osmotic flow of interstitial fluids. In addition to buffer-solutions, calibration solutions, and washing solutions are employed, stored on-chip, and pumped and valved as required for the intended operation.

While several micro-fluidic systems 6 are small, the instrumentation and circuitry required to control the micro-fluidics and to operate the sensor systems to monitor the samples are complex, remain large, are not integrated into the micro-fluidic system, and are often expensive. This is acceptable for laboratory or hospital work, but it is not practical for either ambulatory utilization or autonomous operation (i.e. laboratory-on-a-chip). The miniature size of the micro-fluidic sensing system with integrated instrumentation circuitry reported here is required for many applications, both medical, biological, and industrial (i.e. chemical process control).

For mobile applications, automated control of the pumps, valves, and sensors is required to continuously monitor and calibrate the microscopic “lab-on-a-chip” devices. Using integrated electronics, the sensors can be calibrated on a regular basis in an automated manor that is transparent to the user, ensuring accuracy of the data obtained. The sensing system also requires integrated circuitry to buffer the signals, reduce noise, transduce the chemical concentrations into electronic signals, and analyze the signals, allowing untrained personnel to utilize the device.

Another application for integrated circuitry is for the telemetric communication of the device with a base unit, which can then relay the information to a remote location. Moreover, the circuitry can perform closed-loop feedback control for biological applications. For example, closed-loop feedback control can be used to inject insulin into an individual when the transdermal sensor system detects hyperglycemic levels of glucose in the transdermally sampled interstitial fluid, thereby maintaining euglycemia.

The sensor arrays are fabricated in a three-mask process with two metal layers, silver and platinum. Since these metals are difficult to etch using wet chemistry, a resist lift-off process was used to pattern them. This provided an additional advantage in allowing the use of layered materials in a metal structure to modify electrode properties and still allowed for patterning to occur in one step.

Additionally, other sensor conformations can be produced in accordance with the present invention, each with differing transduction and membrane encapsulation properties. These designs incorporate rectangular, circular, and concentric circle shaped electrodes.

The sensor arrays are ideal for use in a micro-fluidic transdermal patch system in that they provide a large number of individual sensors, each of which can be encapsulated by a different membrane using the automated micro-screen printing device, the New Long LS-15TV, to confer sensitivity to individual biological ions and molecules of interest. Multiple conformations of sensor arrays are constructed using electrode sizes of 2, 4, 8, 32, and 100 μm.

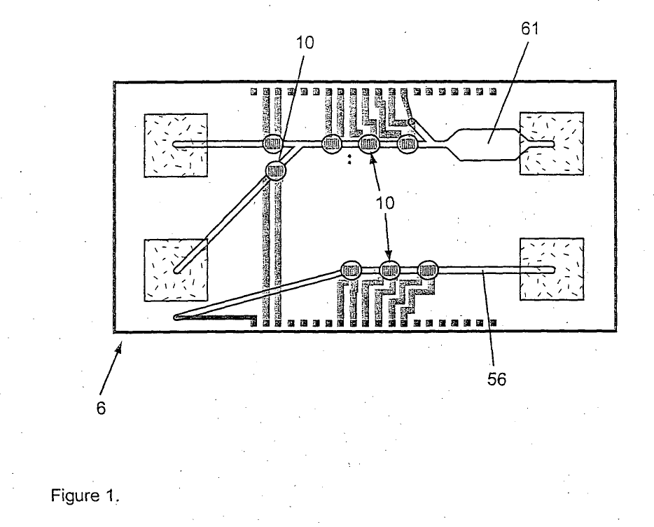

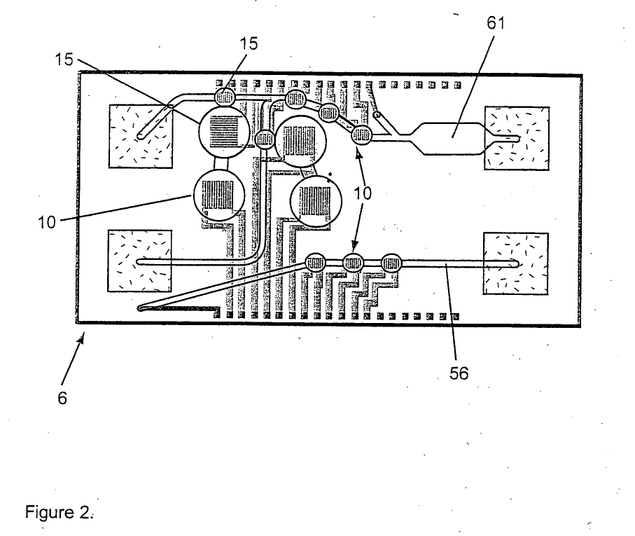

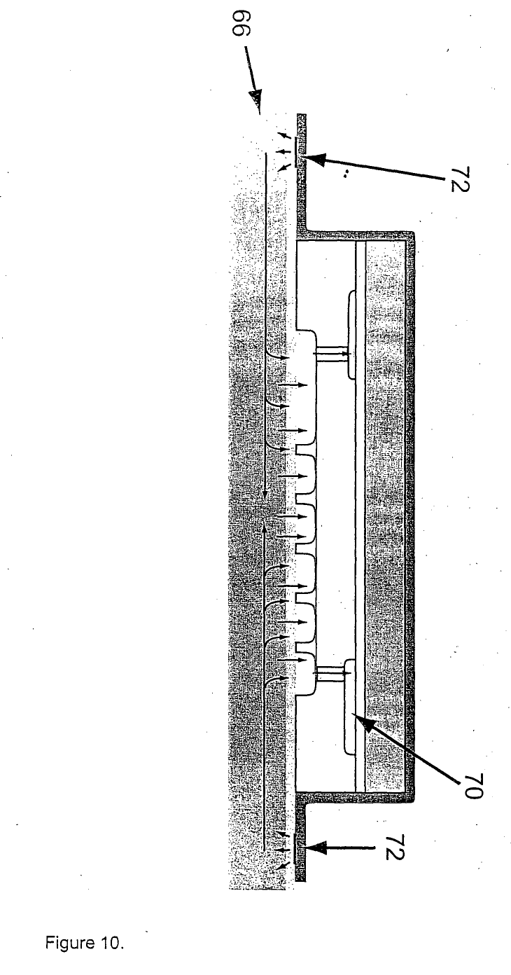

FIGS. 1 and 2 show a top view schematic layout of the micro-fluidic pumping system. In this example, two micro-fluidic pumps are utilized as the driving force for a transdermal monitoring system able to minimally invasively monitor the concentration of circulating hormones, drugs, electrolytes, toxins, etc. in ambulatory human subjects, continuously and in real-time. This includes two micro-fluidic bi-stable valves for the valving of the calibration/wash solutions; three micro-actuators in series to effect peristaltic pumping, with two separate pumps on the same chip; the optional integrated ampermetric/potentiometric/optical sensor array in the sensor chamber; the waste fluid, calibration/wash solutions, and buffer solution reservoirs; and bonding pads for interconnecting wires. Also, incorporated are two different layouts of the transdermal sampling chamber 60 (FIGS. 10-12). Not shown are thermistor/thermocouple regulator, sensor chamber heater for accelerated assay control, integrated power supply, and integrated control electronics which can optionally be included.

In any embodiment, the valves of the present invention utilize an actuating mechanism 10 to occlude a micro-conduit 20 and thereby decreasing or preventing fluid flow. The ability to occlude is selective, in that the valve can effectively open and close a passageway of the micro-conduit. The micro-fluidic actuators 10 are the driving mechanism behind the micro-fluidic valves 22 of the present invention.

The micro-fluidic valve 22 has various pressures and temperatures required for their actuation. The valve 22 can be selectively controlled and actuated through an integrated CMOS circuit or computer control, which controls actuation timing, electrical current, and heat generation/dissipation requirements for actuation. Integration of control circuitry is important for reduced power requirements of the present invention. In one particular embodiment for example, sensors and circuitry responsible for monitoring the effluent of a fuel cell, with concomitant control of the micro-fluidic fuel delivery system to increase or decrease the flow rate of fuel, is designed. This ensures optimal fuel utilization in the device. Closed loop feedback provides the basis of automated adjustment of circuitry and therefore, valving, within the micro actuator. In another embodiment, closed loop feedback control can be used to inject insulin into an individual when the transdermal sensor system detects hyperglycemic levels of glucose in the transdermally sampled interstitial fluid, thereby maintaining euglycemia.

In one embodiment of the present invention, the actuator 10 includes a closed cavity 11, flexible mechanism 18, and expanding mechanism 14. Fabrication of actuators 10 is accomplished by generating optical and/or electron-beam (e-beam) masks from the CAD designs of the micro-fluidic system. Then, using solid-state mass production techniques, silicon wafers are fabricated and the flexible mechanisms 18 for the actuators 10 subsequently are placed on the chips.

In the device without integrated circuitry, the control circuitry is produced on external breadboards and/or printed circuit boards. In this manner, the circuitry is easily, quickly, and inexpensively optimized prior to miniaturization and incorporation as CMOS circuitry on-chip that can be controlled manually, or through the use of a computer with digital and analog output. Optimized CMOS circuitry, modeled utilizing solid state MEMS and CMOS design and simulation tools, is integrated into the active device making it a stand-alone functional unit.

Electronic control of the actuators 10 is optimized to maximize pumping rates and valving forces, and to minimize power utilization and heat generation. An e-prom is also included on-chip to provide digital compensation of resistors and capacitors to compensate for process variations and, therefore, improve the process yield. Electrical access/test pads are designed into the chips to allow for the testing of internal nodes of the circuits.

The liquid or gaseous fluid being valved serves the purpose of acting as a heat sink to condense the gas back to liquid and hence return the flexible mechanism 18 to is relaxed state when the heating mechanism 12 is inactivated. A temperature sensor 16 is integrated adjacent to the actuator 10 to monitor the temperature of the micro-fluidic integrated: heating mechanism 12 and hence, expanding mechanism 14.

Once the heating mechanism 12 is activated, vaporization of the expanding mechanism 14 takes place. The expanding mechanism 14 component imposes a pressure upon the flexible mechanism 18 causing it to expand and be displaced above the heating mechanism 12 and reduce the volume of the chamber 20. This methodology can be utilized to occlude fluid is flow through the chamber 20 (valving action, see FIG. 3).

For the mono-stable valve, it is assumed that the temperature on both sides of the SiO₂ that encapsulates the heating mechanism 12 is constant, and that heat flux in each direction is dependent upon the heating mechanism, 12 temperature and the resistance to heat flow either through the device or to the air from the backside. In order to isolate the heater, a cavity is etched in the backside of the wafer, providing thermal isolation.

In one embodiment, a mono-stable valve 22 requires continuous power to maintain a closed-stated position. Utilizing the heating mechanism 12, an expanding mechanism 14 is vaporized under the encapsulating flexible mechanism 18 thereby providing the pneumatic driving force required to expand the flexible mechanism 18 and hence occluding the micro-conduit 20.

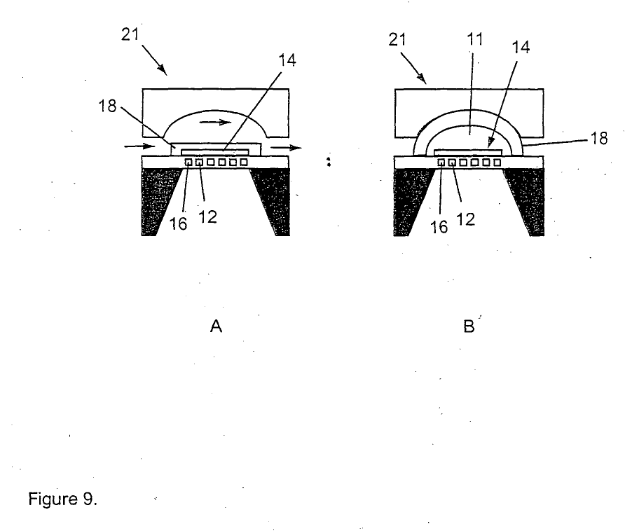

The mono-stable, normally open valve utilizes a single actuator to effectively actuate the valve. As the hydrogel is expanded, the silicone rubber of the actuator, completely occludes the micro-fluidic channel to effect valving of the solution. Schematics of the mono-stable valves are presented in FIGS. 3 and 9 and are depicted in the layout of the entire micro-fluidic system design presented in FIGS. 1,2, and 4. While the normally open valve is less complicated to construct, it requires continuous power or pulsed power to keep the valve closed.

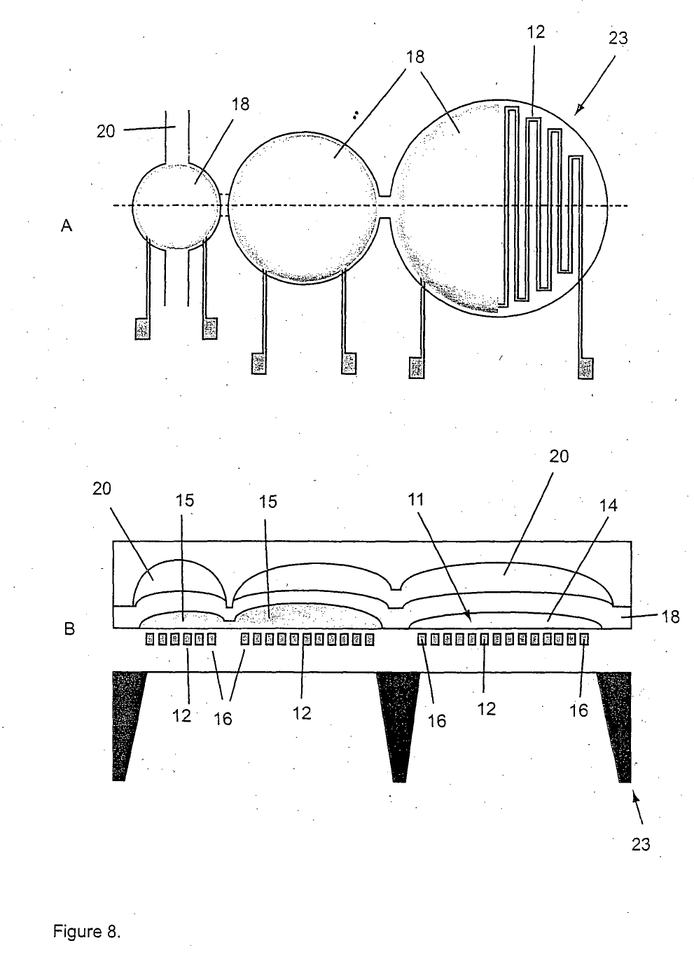

In another embodiment of the present invention, a bi-stable valve is designed that utilizes lower power consumption and a wax material to provide passively open and passively closed functionality, i.e. bi-stability. Thus, power is only required to transition from one state to the other. The bi-stable valve design is based upon the utilization of a moderate melting point solid, such as paraffin wax, which possesses a melting point between 50° C. and 70° C. FIG. 8a shows a top view and 8b shows a cross-section of the bi-stable valve in the open state. The two actuators on the left, which contain the paraffin wax, are connected to each other by a fluid conduit.

The bi-stable valve 23 similarly utilizes actuating mechanisms 10 to occlude the micro-conduit 20. The mono-stable valve can only provide the is functionality of a normally open valve. During the period that the valve 23 must be maintained in a closed position, continuous power must be applied. In this embodiment, there is a bi-stable valve 22 that utilizes micro-fluidic actuators 10 to provide both zero-power open and closed functionality.

The bi-stable valve utilizes a total of three micro-fluidic actuating mechanisms 10, 15. Although, any number of actuating mechanisms 10, 15 can be used without departing from the spirit of the present invention. Two actuating mechanisms 15 are physically connected by a micro-fluid conduit formed under the membrane and are filled with a low melting point solid such as paraffin wax as opposed to an aqueous hydrogel 14 (see above for mono-stable actuation). The third is a standard design micro-actuator 10 filled with an aqueous hydrogel connected by the expansion chamber to the middle wax filled actuator 15. The first two micro-actuators 15 are activated causing the wax to melt. The third, standard, micro-actuator 10 is then activated, providing pneumatic force on the wax containing actuators 15, causing the orifice containing chamber 20 to close. The wax is then allowed to solidify. Again, the advantage of this valve 22 is that it requires power only to transform from the stable open to the stable closed state.

In the open state, medium in the channel readily flows. To switch from the open state to the closed state, the wax is melted and the pneumatic actuator 10 on the right is expanded. This creates pressure outside the middle actuator 15, forcing the paraffin into the smaller left chamber, expanding the membrane, thereby blocking fluid flow. The wax is allowed to solidify, after which the power can be removed from the actuator providing the driving force pressure, resulting in an electrically passive closed state. To transition from the closed state to the open state, the wax is melted and membrane tension forces the wax from the small left chamber back into the middle chamber. The micro-valve design provides bi-stable functionality, which only requires power to switch between each state, but is completely passive once in either the open or closed position.

The time to heat and cool the wax in the bi-stable valve is calculated using Fick's equation for unsteady-state heat transfer. The partial differential equation is reduced to solving simultaneous ordinary differential equations using numerical methods of lines with Polymath Software.

To calculate the unsteady-state heating and cooling, it is necessary to assume an insulated boundary at one side of the wax and either a convective (cooling) or a conductive constant temperature. (heating) boundary at the other side. The assumption of the insulating boundary is appropriate for the 400 μm radius middle wax chamber since there is a pocket of air on the other side of the membrane that is in contact with the wax. This can be approximated as an insulated boundary.

In one embodiment, three actuators are needed for implementation of the bi-stable valve. Wax is contained in the small actuator 15 in the left chamber, which is in the shape of a hemisphere with radius of 140 μm and a height of 20 μm when the valve is open and a height of 120 μm when the valve is closed. The middle chamber has a radius of 400 μm and a height of 30 μm when the valve is open, and when closed, the wax is be forced into the small chamber leaving a height of 20.25 μm. Using these dimensions to calculate the volume of wax in each chamber yields 1.23 nL of solid wax in the small chamber and 15 nL of solid wax in the middle chamber with the valve open (i.e. membranes relaxed).

The insulating assumption used for the small 120 μm wax slab, in the expanded valve, which blocks the fluid channel, is a conservative assumption and provides a maximum cooling time using only a convective boundary on one side of the wax. A more realistic estimate is similar to that of the constant temperature boundary condition, with the flowing solution in the channel as the constant temperature sink. The speed at which the wax is forced into the channel, thereby closing the valve, affects the cooling time of the wax. When the valve is closed slowly, the flowing solution in the channel absorbs heat from the wax, thereby reducing cooling time. If the valve is closed quickly, heat from the wax is not able to be transferred to the solution, hence increasing cooling time.

The time required to heat the wax is significantly shorter than that required to cool the wax. This is true since heating uses a constant temperature source at the boundary (an embedded poly-silicon or other type of heater) without thermal resistance to the wax, and the cooling calculations utilized a high thermal convective resistance (air).

It is important to consider expansion and contraction of the wax during heating and cooling: slower cooling rates combined with the use of a lower melting point wax can reduce shrinkage of the wax after it has occluded the channel. To eliminate problems with shrinkage and thermal breakdown, the wax should not be heated to a temperature greater than that necessary for it to liquefy. For a typical paraffin wax, the temperature should be kept below 65° C. to prevent oxidation. Paraffin wax has a melting point of 60° C. and a congealing point of 59° C., therefore the temperature range of phase transition is narrow, thereby providing a uniform temperature distribution and uniform melting. Other types of waxes have a wider temperature range of phase transition that can be used for other temperature range applications.

The thermal shrinkage of the wax is important because too much shrinkage would allow the valve to open slightly, thereby allowing solution to pass. Based upon the densities of melted and solidified wax, the contraction of the wax in the device is calculated to be approximately 9 percent, and the device can be optimized by utilizing methods to force more wax into the chamber to account for this shrinkage. A slower cooling rate applied to the wax reduces shrinkage. Another method to compensate for shrinkage involves cooling the left, valving chamber while the middle and right chambers remain heated. This forces more wax into the valving chamber as the wax cools. The power required to melt the wax is also important to consider and minimize. The calculated steady-state heat flux through each wax slab in the device is calculated to be approximately 550 W/m².

In one embodiment, to calculate the pressure required to actuate the valving membrane, the overlap between the two chambers with wax-based is actuators is estimated to be approximately 200 μm wide. Using the thickness of the wax in the small valving chamber, the height is calculated to be 20 μm. The pressure required to push melted wax through a 200 by 20 μm channel, modeled as parallel plates, is 0.06 ATM or 0.9 psi above atmosphere, a readily obtainable pressure.

The method of actuation is as follows. The heating mechanism 12 is activated, thereby vaporizing the fluid component of the vaporizable fluid 14. The vaporized fluid 14 component imposes a pressure upon the membrane 18 causing it to expand (be displaced above the heating mechanism 12) and completely fill the chamber 20. This methodology can be utilized to occlude fluid 14 flow through the chamber 20 (valving action), or can be used for other purposes such as providing direct contact to the glass substrate to effect heat transfer or to provide the driving force for locomotion of a physical device (i.e. as in a walking caterpillar and/or a swimming paramecium with a flapping flagella, in which case the glass chamber 20 encompassing the micro-actuator 10 would not be used).

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A micro-fluidic sensor system comprising:
a micro-conduit for carrying fluid therethrough including a flexible wall portion;
at least one micro-fluidic actuator including a closed cavity, flexible means defining a wall of said cavity and said, flexible wall portion of said micro-conduit for deflecting upon an application of pressure thereto, and expanding means disposed in said cavity for selectively expanding said cavity and thereby selectively flexing said expanding means; and
sensor means in fluid communication with said micro conduit for sensing amounts of molecules.

2. The micro-fluidic sensor system according to claim 1, wherein said flexible means is made from material selected from the group consisting essentially of silicone rubber, rubber, polyurethane, PVC, polymers, and combinations thereof.

3. The micro-fluidic sensor system according to claim 1, wherein said expanding means includes vaporizable fluid selected from the group consisting essentially of water, hydrocarbon, and hydrogel.

4. The micro-fluidic sensor system according to claim 1 including heating means disposed adjacent to said flexible means for selectively expanding said expanding means.

5. The micro-fluidic sensor system according to claim 4, wherein said heating means includes an integrated heating element made from material selected from the group consisting essentially of polysilicon, elemental metal, and silicide.

6. The micro-fluidic sensor system according to claim 4, wherein said heating means includes a temperature sensor made from material selected from the group consisting essentially of polysilicon, elemental metal, and silicide.

7. The micro-fluidic sensor system according to claim 4, wherein said heating means is operatively connected to and powered by a battery.

8. The micro-fluidic sensor system according to claim 1 further defined as a planar micro-fluidic system.

9. The micro-fluidic sensor system according to claim 1 including a valve having a micro-conduit for carrying fluid therethrough and at least one said micro-fluidic actuating means for selectively deflecting at least a portion of a wall of said micro-conduit occluding fluid flow through said micro-conduit.

10. The micro-fluidic sensor system according to claim 9, wherein said valve is a mono-stable valve having a normally open position thereby allowing fluid flow and an actuated closed condition thereby occluding fluid flow through said micro-conduit.

11. The micro fluidic valve according to claim 10, wherein said mono-stable valve includes a partially open position, whereby said open position is controlled by said actuating means.

12. The micro-fluidic sensor system according to claim 9, wherein said valve is a bi-stable valve includes at least three actuating means.

13. The micro-fluidic sensor system according to claim 12, wherein at least two said actuating means includes expanding means made of wax.

14. The micro-fluidic sensor system according to claim 12, wherein said actuating means includes a zero power closed condition and a zero power open condition thereby creating a bi-stable valve.

15. The micro fluidic valve according to claim 14, wherein said actuating means further includes a partially open position, thereby creating a partial occlusion of said micro conduit.

16. The micro-fluidic sensor system according to claim 1 including a chamber having wall means for defining said chamber, said wall means including at least one pulsating portion actuable to pulse and change an interior volume of said chamber defined by said wall means.

17. The micro-fluidic sensor system according to claim 16, wherein said chamber is selected from the group consisting essentially of a tube, pipe, planar channel, and conduit.

16. The micro-fluidic sensor system according to claim 16, wherein said wall means is made from material selected from the group consisting essentially of silicon, glass, rubber, silicone, plastics, metal, ceramics, polymers, and combinations thereof.

17. The micro-fluidic sensor system according to claim 16, wherein said pulsating portion is made from materials selected from the group consisting essentially of rubber, silicone, plastics, silicon, metal, and polymers.

18. The micro-fluidic sensor system according to claim 17, wherein said pulsating portion includes entire said wall means, or portion thereof.

19. The micro-fluidic sensor system according to claim 18, wherein said pulsating portion is made from materials different from materials of said wall means.

20. The micro-fluidic sensor system according to claim 1 including a micro-fluidic pump having a micro-conduit for carrying fluid therethrough and at least one said actuating means for peristaltically moving fluids through said micro-conduit.

21. The micro-fluidic sensor system according to claim 20, further including series of said actuating means working in tandem to peristaltically move fluids.

22. The micro-fluidic sensor system according to claim 21, wherein said series of actuating means are operatively connected by said micro-conduit.

23. The micro-fluidic sensor system according to claim 1, wherein said sensor means includes integrated chemical and physical sensors.

24. The micro-fluidic sensor system according to claim 1, wherein said sensor means includes a closed-loop feedback to control devices selected from the group consisting essentially of microfluidics, internal hardware, external hardware, control devices, and control computers.

25. The micro-fluidic sensor system according to claim 1 further including integrated circuitry for controlling said actuating means.

26. The micro-fluidic sensor system according to claim 1 further including a calibrating means for calibrating said micro-fluidic system.

27. The micro-fluidic sensor system according to claim 1 further including a telemetry system electronically connected to said micro-fluidic system.

28. The micro-fluidic sensor system according to claim 1 further including sampling chambers.

29. The micro-fluidic sensor system according to claim 26, wherein said sampling chambers further include teardrop-shaped standoff posts.

30. A micro-fluidic system according to claim 1, further including integrated circuitry.

31. A micro-fluidic system comprising:
a micro-conduit for carrying fluid therethrough including a flexible wall portion; and
at least one micro-fluidic actuator in fluid communication with said micro-conduit including a closed cavity, flexible means defining a wall of said cavity and said flexible wall portion of said micro-conduit for deflecting upon an application of pressure thereto, and expanding means disposed in said cavity for selectively expanding said cavity and thereby selectively flexing said expanding means.

32. A micro-fluidic sampling chamber comprising mixing means for mixing fluids flowing therethrough.

33. The micro-fluidic sampling chamber according to claim 32, wherein said mixing means includes teardrop-shaped stand-off posts.
